(19) United States
(12) Patent Application Publication
(10) Pub. No.: US 2022/0075871 A1
(43) Pub. Date: Mar. 10, 2022

(54) DETECTING HACKER TOOLS BY LEARNING NETWORK SIGNATURES

(71) Applicant: Microsoft Technology Licensing, LLC, Redmond, WA (US)

(72) Inventors: Roy LEVIN, Haifa (IL); Idan HEN, Tel Aviv (IL)

(21) Appl. No.: 17/063,278

(22) Filed: Oct. 5, 2020

Related U.S. Application Data
(60) Provisional application No. 63/076,230, filed on Sep. 9, 2020.

(51) Int. Cl. G06F 21/55; G06F 21/56; G06F 21/53; G06N 20/00

(52) U.S. Cl. CPC G06F 21/554; G06F 21/564; G06N 20/00; G06F 21/552; G06F 21/53

(57) ABSTRACT

Methods, systems and computer program products are provided for detection of hacker tools based on their network signatures. A suspicious process detector (SPD) may be implemented on local computing devices or on servers to identify suspicious (e.g., potentially malicious) or malicious executables. An SPD may detect suspicious and/or malicious executables based on the network signatures they generate when executed as processes. An SPD may include a model, which may be trained based on network signatures generated by multiple processes on multiple computing devices. Computing devices may log information about network events, including the process that generated each network event. Network activity logs may record the network signatures of one or more processes. Network signatures may be used to train a model for a local and/or server-based SPD. Network signatures may be provided to an SPD to detect suspicious or malicious executables using a trained model.

### CROSS-REFERENCE TO RELATED APPLICATION(S)

The present application claims priority to U.S. Provisional Patent Application No. 63/076,230, entitled “DETECTING HACKER TOOLS BY LEARNING NETWORK SIGNATURES,” and filed on Sep. 9, 2020, the entirety of which is incorporated by reference herein.

### BACKGROUND

Hackers may launch attacks after using a variety of tools, including reconnaissance tools that collect information. Some of the tools used by hackers may have legitimate uses in addition to their usefulness in hacking.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems and computer program products are provided for detection of hacker tools based on their network signatures. A suspicious process detector (SPD) may be implemented on local computing devices or on servers to identify suspicious (e.g., potentially malicious) or malicious executables. The SPD is configured to detect suspicious and/or malicious executables based on the network signatures they generate when executed as processes. In this way, executables modified to evade detection (e.g., based on binary signatures) may be detected. Suspicious executables may be identified based on their network signature before resorting to costly execution in isolation (e.g., for additional monitoring and analysis), which some nefarious executables may detect and use to conceal operation. An SPD may include a model (e.g., a machine learning model). A model may be trained, for example, based on network signatures generated by multiple processes on multiple computing devices. Computing devices log information about network events (e.g., transmitted network packets), including the process that generated each network event. Network activity logs record the network signatures of one or more processes. Network signatures may be used to train one or more models for one or more local and/or server-based SPDs. Network signatures (e.g., in logs) may be provided to local or server-based SPDs (e.g., with one or more trained models) for analyses and detection of suspicious or malicious executables.

Further features and advantages of the invention, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a system for detection of hacker tools based on their network signatures, according to an example embodiment.

FIG. 2 shows a block diagram of a process monitor that logs network activity associated with various processes, according to an example embodiment.

FIG. 3 shows a block diagram of training and using a machine learning model to detect hacker tools based on their network activities or signatures, according to an example embodiment.

FIG. 4 shows a flowchart of a method for training a machine learning model to detect hacker tools based on their network activities or signatures, according to an example embodiment.

FIG. 5 shows a flowchart of a method for using a trained machine learning model to detect hacker tools based on their network activities or signatures, according to an example embodiment.

FIG. 6 shows a block diagram of an example computing device that may be used to implement example embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an example embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Implementations

Hackers may launch attacks after using a variety of tools, such as reconnaissance tools to collect information. One or more such tools may lay the foundation for an impending attack. Some tools used by hackers may have legitimate uses. For example, reconnaissance tools may be used to map network structure, e.g., including ports and security features. For example, Nmap is an open-source network scanner/reconnaissance tool that discovers hosts and services on a computer network by sending packets and analyzing the results. Nmap may be used to map out a network structure by scanning behavior, and thus may be used as or used by (or incorporated in) a hacker tool. A hacker tool may be identified, for example, at a binary level, such as by the name or binary signature of the tool. However, binary level identification may be tricked, such as by renaming the binary and/or by changing the binary in a way that preserves its logic useful to hackers.

A hacker tool may be identified by other techniques, such as by running a binary (e.g., an executable, application, program) inside a dedicated sandbox environment called a detonation chamber and monitoring its behavior (e.g., to determine whether the binary is nefarious). However, sandbox detection is very expensive because it typically requires creating a VM (virtual machine) for each binary, and each binary may run for several minutes. Some binaries can detect that they are running in a sandbox and modify their behavior to avoid detection.

According to embodiments, hacker tools may be detected in a more robust manner, for example, based on their network behavior. Detection based on network behavior is not vulnerable to detection avoidance techniques, for example, when executables are run as processes in an actual machine (e.g., not in an isolated environment such as a sandbox) to determine network activity/signatures. One or more machine learning (ML) models may be trained and used to detect whether an executable is suspicious (suspect or potentially malicious) or malicious based on the network activity/signature generated by the executable when run as a process in a computing environment executing multiple processes.

In embodiments, model training and/or use of a trained model may be implemented, for example, on a network server (e.g., as a network/cloud service in a network/cloud environment, such as Microsoft® Azure®). For example, one or more entities (e.g., customers, etc.) may install a network/cloud agent on one or more computing devices to provide network activity/signature logs, receive trained models, and/or receive suspicious and/or malicious process detection results. An agent may be, for example, a Microsoft® Azure® Security Center agent, or other type of agent. An agent may be executed on a user's computing device (e.g., in a VM). A process monitor (e.g., a network activity monitor) may collect/log network activity (e.g., network traffic data) generated by each of multiple binaries that are running on a user's computing device (e.g., in a VM). An agent may provide network activity logs to a server, for example, to train a model and/or to detect suspicious and/or malicious processes using a trained model. Model features may be extracted from network activity logs and transformed into a format expected by a model.

In embodiments, training sets of network activity/signatures may be generated with labels indicating whether a network signature represents a suspicious, malicious, or non-suspicious/malicious executable. A label may indicate a class. Classification may be binary (e.g., suspicious and not suspicious) or may have more than two classes (e.g., suspicious, not suspicious and malicious or not suspicious and any of multiple general or specific types of suspicious or malicious binaries classes). Training labels may be determined, for example, by examining network activity logs received from multiple user/customer computing devices relative to known potentially malicious and/or malicious/nefarious applications (e.g., Nmap, Wireshark (an open-source packet analyzer)) and non-suspicious/malicious applications. Labeled network signatures may be determined, for example, by logging network signatures for known suspicious and/or malicious binaries, which may be known, for example, based on their binary names or signatures. Suspicious and/or malicious binaries may be referred to (e.g., defined) as seeds for training one or more machine learning (ML) components (e.g., one or more ML models, such as one or more classifiers) to learn their network footprints/signatures. Network footprints/signatures generated by execution of non-suspicious/malicious binaries may be referred to as non-seeds for training one or more ML components. Any classification method may be used in a variety of implementations of suspicious (e.g., potentially malicious or malicious) process detection based on network signature.

A trained model may be applied over a network activity/signature log to identify suspicious binaries based on network footprints/signatures, which may provide detection of suspicious and/or malicious executables run as processes regardless whether a binary signature is changed in an attempt to avoid detection. Detections may be used to make one or more analyses (e.g., determine the context of execution to distinguish legitimate from illegitimate execution), make one or more determinations, and/or to take one or more actions (e.g., stop/block execution, engage in additional analysis, such as in a sandbox, etc.).

Embodiments for detecting hacker tools may be configured in various ways, and numerous embodiments are described in detail as follows.

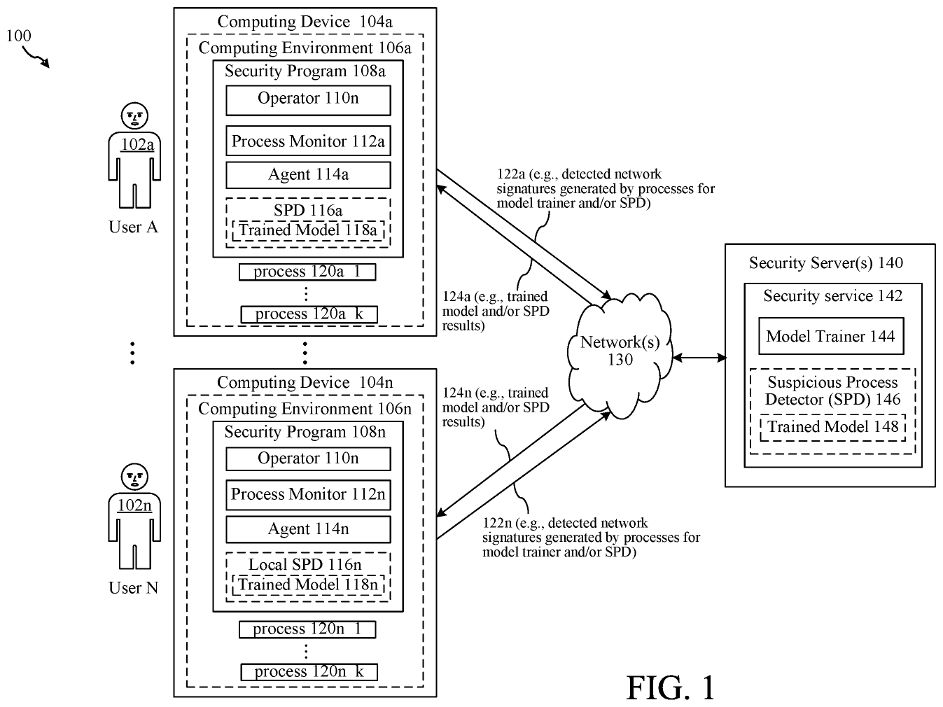

For instance, FIG. 1 shows a block diagram of a networked computer security system 100 configured for detection of hacker tools based on their network signatures, according to an example embodiment. System 100 presents one of many possible example implementations. Example system 100 may comprise any number of computing devices and/or servers, such as the example components illustrated in FIG. 1 and other additional or alternative devices not expressly illustrated. Other types of computing environments involving detection of suspicious executables based on network signatures are also contemplated. As shown in FIG. 1, system 100 includes a plurality of computing devices 104a-104n and one or more security servers 140 that are communicatively coupled by one or more networks 130. Computing devices 104a-104n (having respective users 102a-102n) host and execute respective security programs 108a-108n and respective processes (e.g., 102a_1-k, 102n_1-k) in respective computing environments 106a-106n. Security server(s) 140 host and execute a security service 142 that includes a model trainer 144 and an optional suspicious process detector (SPD) 146. Security programs 108a-108n and/or security service 142 may each include a respective suspicious process detector (SPD) (e.g., local SPDs 116a-116n of security programs 108a-108n and/or network service-based SPD 146 of security service 142), which may be based, respectively, on one or more trained models (e.g., trained model(s) 118a-118n, 148). The features of system 100 are described in further detail as follows.

Network(s) 130 may include one or more of any of a local area network (LAN), a wide area network (WAN), a personal area network (PAN), a combination of communication networks, such as the Internet, and/or a virtual network. In example implementations, computing devices 104a-104n and security server(s) 140 may be communicatively coupled via network(s) 130. In an implementation, any one or more of security server(s) 140 and computing devices 104a-104n may communicate via one or more application programming interfaces (APIs), and/or according to other interfaces and/or techniques. Security server(s) 140 and/or computing devices 104a-104n may include one or more network interfaces that enable communications between devices. Examples of such a network interface, wired or wireless, may include an IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc. Further examples of network interfaces are described elsewhere herein. Various communications between networked components may utilize, for example, HTTP (Hypertext Transfer Protocol), Open Authorization (OAuth), which is a standard for token-based authentication and authorization over the Internet). Information in communications may be packaged, for example, as JSON (JavaScript Object Notation) or XML (Extensible Markup Language) files.

Computing devices 104a-104n may comprise computing devices utilized by one or more users (e.g., individual users, family users, enterprise users, governmental users, administrators, hackers, etc.). Computing devices 104a-104n may comprise one or more applications, operating systems, virtual machines (VMs), storage devices, etc. that may be executed, hosted, and/or stored therein or via one or more other computing devices via network(s) 130. In an example, computing devices 104a-104n may access one or more server devices, such as security server(s) 140, to provide information, request one or more services and/or receive one or more results. Computing devices 104a-104n may represent any number of computing devices and any number and type of groups (e.g., various users among multiple cloud service tenants).

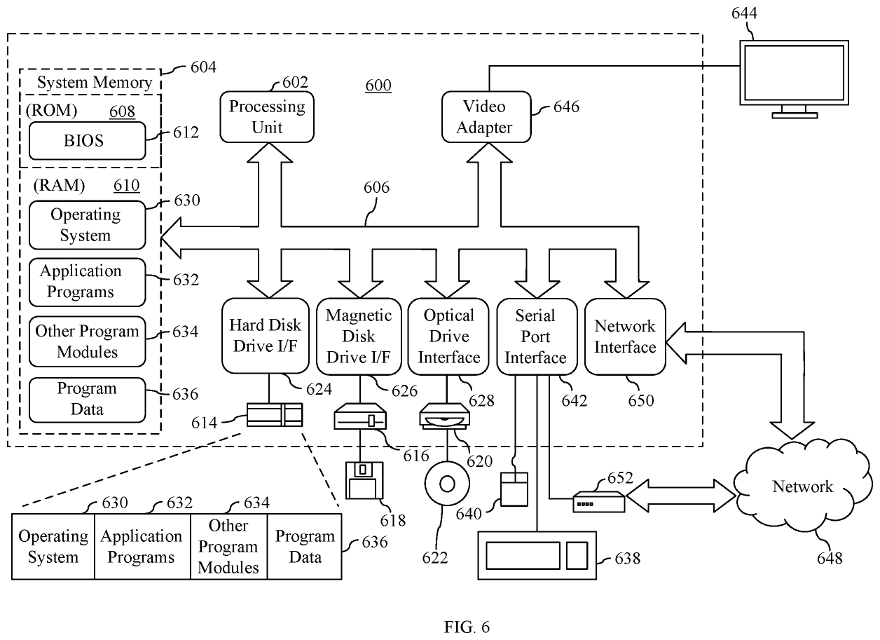

User(s) 102a-102n may represent any number of persons authorized to access one or more computing resources. Computing devices 104a-104n may each be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer), or a server. Computing devices 104a-104n are not limited to physical machines, but may include other types of machines or nodes, such as a virtual machine. Computing devices 104a-104n may each interface with authentication and authorization server(s) 118, for example, through APIs and/or by other mechanisms. Any number of program interfaces may coexist on computing devices 104a-104n. An example computing device with example features is presented in FIG. 6.

Computing devices 104a-104n have (e.g., host and/or contain) respective computing environments 106a-106n. Computing devices 104a-104n may execute one or more processes in their respective computing environments 106a-106n. A computing environment may be any computing environment (e.g., any combination of hardware, software and firmware). A computing device may execute multiple processes in a computing environment, including k processes (e.g., where k may be any number). For example, computing device 104a may execute processes 1-k (e.g., process 120a_1-120a_k) in computing environment 106a. Computing device 104n may execute processes 1-k (e.g., process 120n_1-120n_k) in computing environment 106n. Various computing devices may execute any number of processes, which may be different processes and/or a different number of processes compared to other computing devices. A process (e.g., a process 120) may be any type of process. A process is any type of executable (e.g., binary, program, application) that is being executed by a computing device.

Users 102a-102n may use computing device 104a-104n, for example, to opt into one or more types of security analysis/protection, such as suspicious process detection based on network signatures generated by processes. Security programs 108a-108n and/or security server(s) 140 may provide one or more user interfaces (e.g., one or more graphical user interfaces (GUIs)), for example, for users 102a-102n to interact with to select security services, which may include information sharing. Users 102a-102n may indicate whether an agent (e.g., for another computing device and/or server) can be installed, whether the user will share data from the user's computing device with one or more other computing devices (e.g., security server(s) 140), whether the user prefers suspicious process detection as a network service (e.g., SPD 146) or a local implementation of SPD on the user's computing device (e.g., SPD 116). Selection of a local SPD may authorize download of a trained model (e.g., trained model 118). Users 102a-102n may permit their respective computing devices to download, install and run an agent of security server(s) 140 (e.g., a cloud application) in support of one or more selected security services. For example, an agent may be used to provide security server(s) 140 access to data collected by a computer's process monitor (e.g., network activity monitor, capturing tool and/or log generator) about processes running in respective computing environments 106a-106n. In some examples, agents 114a-114n may each provide a respective communication link between computing devices 104a-104n and security server(s) 140 (e.g., between security programs 108a-108n and security service 142).

Security programs 108a-108n may provide one or more types and/or levels of security for respective computing devices 104a-104n. Security programs 108a-108n may each be any type of security program. In various implementations, one or more of the components shown in security programs 108a-108n may be implemented outside security programs 108a-108n. Security programs 108a-108n (e.g., or one or more components thereof) and/or one or more other monitors executing in respective computing environments 106a-106n may monitor one or more processes (e.g., respective processes 120a_1-k, 120n_1-k) executing in respective computing environments 106a-106n on respective computing devices 104a-104n. In various implementations, security programs 108a-108n may monitor processes, collect (e.g., record or log) information about processes (e.g., network activity), provide information about processes to another computing device (e.g., security server(s) 140), receive trained model(s), receive suspicious process detection results, detect suspicious processes locally, use detection results to determine whether to take any action and what action to take based on detection of one or more suspicious processes, and so on. Security programs 108a-108n may include (e.g., respectively), for example, one or more of operators 110a-110n, process monitors 112a-112n, agents 114a-114n, and/or local suspicious process detectors (SPD) 116a-116n.

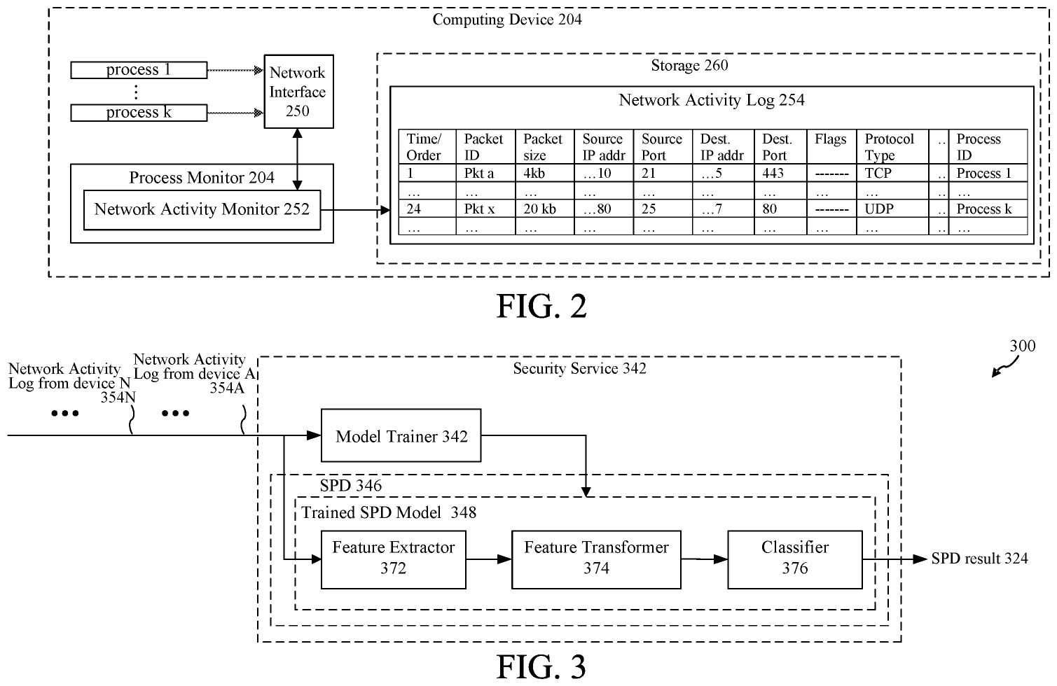

Security programs 108a-108n may each include a respective one of process monitors 112a-112n. Process monitors 112a-112n may monitor multiple processes 120a-120n (e.g., 102a_1-k, 102n_1-k) executing in respective computing environments 106a-106n. For example, a process monitor may include a network activity monitor (e.g., as shown by example in FIG. 2). Process monitors 112a-112n (e.g., via a network activity monitor) may log network activity (e.g., network events) for each of multiple processes executing in a computing environment. Network activity/events may include, for example, a network packet sent by a process. A log may associate a (e.g., each) network event (e.g., packet) with the process that sent it. An accumulation, group or set of network events (e.g., ordered or unordered with or without regard to timing/delays) generated by a process may be referred to as a network signature generated by a process. Network signatures of processes may have varying numbers of network events, for example, based on differences between executables, the number of events used to detect suspicious executables, etc. Process monitors 112a-112n (e.g., via a network activity monitor) may generate a process activity log per process or a log that combines activities by multiple processes.

Security programs 108a-108n may each include a respective one of agents 114a-114n. Agents 114a-114n may be an agent of and may communicate with security service 142. Operations by agents 114a-114n may vary, for example, based on selections by respective users 102a-102n. Agents 114a-114n may (e.g., based on a user selection) provide information 122a-n (e.g., process activity log(s)) to security server(s) 140, e.g., via network(s) 130. Agents 114a-114n may provide process activity logs, for example, for use by security service 142 to train model trainer 144 and/or for suspicious process detector (SPD) 146 to detect suspicious processes (e.g., using trained model 148). Such activity logs may be provided based on a reached threshold (e.g., completion of logging of a predetermined number of network communication events, a predetermined passage of time, etc.), on a periodic basis, upon request, or according to any other schedule. Agents 114a-114n may (e.g., based on a user selection) receive respective information 124a-124n from security server(s) 140 (e.g., via network(s) 130). Information 124a-124n may include, for example, SPD results (e.g., for processing by security programs 108a-108n and/or operators 110a-110n) and/or one or more trained models (e.g., trained models 118a-118n for use by respective local SPDs 116a-116n).

Security programs 108a-108n may include a respective one of local SPDs 116a-116n. Local SPDs 116a-116n may receive a respective one of trained models 118a-118n, for example, from security service 142 after model trainer 144 trains a model (e.g., based on information 122a-n provided by security programs 108a-108n). Local SPDs 116a-116n may receive one or more trained models and/or updates for one or more trained models, for example, via agents 114a-114n and network(s) 130. Local SPDs 116a-116n may receive one or more process activity logs (e.g., network activity logs) from process monitors 112a-112n. Local SPDs 116a-116n may apply process activity log(s) to trained models 118a-118n to detect suspicious processes, if any, running in respective computing environments 106a-106n. Local SPDs 116a-116n may provide SPD results (e.g., for any suspicious processes) to security programs 108a-108n and/or operators 110a-110n, for example, for further evaluation, determination(s) and/or action(s)/operation(s).

Security programs 108a-108n may use detection results (e.g., generated by local SPD 118a-118n or by network service based SPD 146) alone or in combination with other information (e.g., context of execution of one or more processes, one or more local and/or network generated security alerts) to determine whether to take any action and, if so, what action to take. For example, based on detection of one or more suspicious processes, security programs 108a-108n may determine a context of execution, such as the relative timing of execution of one or more processes, downloads, etc. Security programs 108a-108n may take one or more actions. For example, security programs 108a-108n may execute one or more suspicious processes in a sandbox to monitor operation in isolation. Security programs 108a-108n may stop operation of a suspicious process, based on one or more determinations.

Security programs 108a-108n may include operators 110a-110n. Security programs 108a-108n may use (e.g., call or instruct) operators 110a-110n to perform one or more operations for security purposes, for example, based on one or more determinations, which may be related to detection of one or more suspicious processes. For example, operators 110a-110n may halt one or more suspicious processes, launch a sandbox to execute a suspicious process in isolation, generate a warning/alert to an operating system and/or a user interface, and/or performed further operations.

Security server(s) 140 may comprise one or more computing devices, servers, services, local processes, remote machines, web services, etc. for providing security-related service(s) to computing devices 104a-104n. In an example, security server(s) 140 may comprise a server located on an organization's premises and/or coupled to an organization's local network, a remotely located server, a cloud-based server (e.g., one or more servers in a distributed manner), or any other device or service that may host, manage, and/or provide security service(s). Security server(s) 140 may be implemented as a plurality of programs executed by one or more computing devices. Security server programs may be separated by logic or functionality (e.g., as shown by example in FIG. 1).

Security server(s) 140 may include security service 142. Security service 142 may provide security-related resources to computing devices 104a-104n, including but not limited to computing or processing resources (e.g., for security knowledge, analyses and determinations). Security service 142 may perform multiple security-related functions, including, for example, collection and analysis of process activity logs from multiple (e.g., tens, hundreds, thousands or more computing devices), model training, suspicious process detection, and/or other security-related services for one or more entities (e.g., individuals and/or organizations), such as aggregating and analyzing one or more types of security-related information from one or more sources, for example, to identify suspicious activity and recommend or take appropriate action.

Security service 142 may include model trainer 144 and (e.g., optionally) SPD 146, which may operate using trained model 148. Model trainer 144 may train (e.g., train, retrain, and/or update) one or more models, for example, based at least in part on process activity logs received from computing devices 104a-104n. Trained models generated by model trainer 144 may be provided to network-based SPD 146 and/or to local SPDs 116a-116n, for example, based on selections made by users 102a-102n. Training may be supervised or unsupervised. A trained model (e.g., trained models 118a-118n, 148) may be (e.g., in various implementations) any type of processing logic (e.g., perform analysis and make a prediction or determination) derived from or generated based on empirical data (e.g., network activity patterns/signatures), which may be referred to interchangeably as logic, an algorithm, a model, a machine learning (ML) algorithm or model, a neural network (NN), deep learning, artificial intelligence (AI), and so on.

SPD 146 may receive trained models 118a-118n, for example, from security service 142 after model trainer 144 trains a model (e.g., based on information 122a-n provided by security programs 108a-108n), such that trained models 118a-118n may all be copies/instances of a same trained model. SPD 146 may receive one or more trained models and/or updates for one or more trained models. SPD 146 may receive one or more process activity logs (e.g., network activity logs) from process monitors 112a-112n. SPD 146 may apply process activity log(s) to trained model 148 to detect suspicious processes, if any, running in respective computing environments 106a-106n. SPD 146 may provide SPD results (e.g., for any suspicious processes) via network(s) 130 and agents 114a-114n to security programs 108a-108n and/or a component therein (e.g., operators 110a-110n), for example, for further evaluation, determination(s) and/or action(s)/operation(s). Security service 142 may forward information 124a-124n (e.g., a trained model and/or SPD results) to respective agents 114a-114n running in respective computing devices 104a-104n.

FIG. 2 shows a block diagram of an example computing device 204 that includes a process monitor that logs network activity associated with various processes, according to an example embodiment. FIG. 2 shows an example of multiple processes (e.g., process 1 through process k) running in a computing environment on computing device 204. A process is an executable (e.g., a binary, program or application) being executed by a processor in computing device 204. One or more processes may generate network activity. As shown by example in FIG. 2, process 1 and process k each generate network activity. Network activity may comprise, for example, generating a network packet for transmission by a network interface of computing device 204 (e.g., network interface 250). A process monitor (e.g., process monitor 204) may include a network activity monitor 252. Network activity monitor 252 is configured to monitor network events for computing device 204. Network activity monitor 252 may interface with network interface 250 to access network events (e.g., to access network packets, other network signals, etc.).

Network activity monitor 252 may generate network activity log 254 to record network activities. A network event may be stored as a row in network activity log 254. Network activity log 254 may identify information about each network event. For example (e.g., as shown in FIG. 2), a (e.g., each) row of network activity log 254 may identify one or more of the following: a time or order of an event (e.g., for relative ordering of events, such as an event number), a packet identifier (ID), a packet size, a source IP (Internet protocol) address, a source port, a destination IP address, a destination port, one or more flags, a protocol type (e.g., transmission control protocol (TCP), user datagram protocol (UDP)), and/or a process ID. Network activity monitor 252 may generate one or more logs. A log may indicate network events for one or more processes. A log may have a name or metadata indicating the log's order relative to other logs, for example, to generate network signatures for multiple processes that may span multiple logs. A combination (e.g., an ordered or unordered set or subset) of network activity events generated by a process may be referred to as the network signature or footprint of the process.

FIG. 3 shows a block diagram of system 300 for training and using a machine learning model to detect hacker tools based on their network activities or signatures, according to an example embodiment. As shown in FIG. 3, system 300 includes security service 342. Example security service is an example of security service 142 shown in FIG. 1, and is shown in one of many possible implementations. Example security service 342 includes a model trainer 342 and an SPD 346. Model trainer 342 may train one or more models for SPD 346, such as trained SPD model 348. Trained SPD model 348 is an example of SPD models 118a-118n and/or 146 shown in FIG. 1. Model trainer 342 and trained SPD model 348 may receive as input an original or modified form of network activity logs generated by one or more computing devices (e.g., computing device A network activity log 354A . . . computing device N network activity log 354N).

Model trainer 342 may train and evaluate (e.g., generate) one or more SPD models. Model trainer 342 may receive as input an original or modified form of network activity logs generated by one or more computing devices (e.g., computing device A network activity log 354A . . . computing device N network activity log 354N). Model trainer 342 may provide (e.g., manual and/or automated) labeling (e.g., pre-classification) of network activity logs, for example, to produce a featurized training dataset (with known labels). A training set may be split into a training set and a testing set. A training process may train a model with a training set. A trained model may be retrained, for example, as needed or periodically (e.g., based on more recent time-series datasets).

Multiple models with multiple (e.g., different) feature sets may be trained (and evaluated). Various machine learning (ML) models may be trained, such as logistic regression, random forest, and boosting decision trees. Various neural network models may be trained and evaluated, such as Dense and LS™ (Long Short-Term Memory). A training process may utilize different settings to determine the best hyper parameters values. In an example of random forest training and evaluation, parameter values may be determined for the number of trees, the depth of each tree, the number of features, the minimum number of samples in a leaf node, etc. In an example of boosting decision trees, parameter values may be determined for the depth of the tree, minimum number of samples in a leaf node, number of leaf lstmnodes, etc. In an example of a neural network, parameter values may be determined to epoch, activation, number of neurons in each layer, and the number of layers.

Trained SPD model 348 may include a feature extractor 372, a feature transformer 374, and a classifier 376. Trained SPD model 348 may receive as input an original or modified form of network activity logs generated by one or more computing devices (e.g., computing device A network activity log 354A . . . computing device N network activity log 354N). SPD model 348 may generate SPD result 324 as a classification that is an indication of whether an executable is suspicious or malicious based on the network signature(s) of the received network activity logs. SPD model 348 may classify network activity logs (e.g., network signatures) for processes based on the training received from model trainer 342. Classifications may include, for example, binary or multiclass classifications. An example of a binary classifier is suspicious and not suspicious. Suspicious may be defined as potentially malicious. Malicious may mean there are no known legitimate uses of an executable. An example of multiclass classifier is malicious, suspicious and neither (e.g., not suspicious or malicious, or safe with no known malicious uses). An example of a multiclass classifier is suspicious (or malicious) type A, suspicious type B, suspicious type C, etc. and not suspicious. Classifications may include or be accompanied by a confidence level, which may be based on a level of similarity to one or more trained network signatures of suspicious and/or non-suspicious signatures.

SPD 346 may operate trained SPD model 348 to detect suspicious (e.g., and/or malicious) executables based on the network signatures they generate when executed as processes. SPD model 348 may comprise feature extractor 372, feature transformer 374 and classifier 376. Feature extractor 372 may extract features from network activity logs. For example, a network activity log may contain more information than a model may utilize to detect suspicious (or malicious) processes. Feature extractor 372 may extract features from information about network events generated by a single process, for example, to evaluate the network signature of that process.

Feature transformer 374 may transform extracted features into a format expected by classifier 376. For example, classifier 376 may be configured for a particular format of network event and/or network signature features for a process. Feature transformer 374 may, for example, convert the output of feature extractor 372 into feature vectors expected by classifier 376. Feature transformer 374 may be trainable. In an example, feature transformer 374 may convert the output of feature extractor 372 from a 3D tensor into an encoded matrix and (e.g., then) an encoded vector to provide as input to classifier 376.

Classifier 376 may classify a network signature of a process (e.g., a featurized, transformed network signature) as one or more classes (e.g., suspicious, not suspicious). Classifier 376 may generate an associated confidence level for a (e.g., each) classification (e.g., prediction).

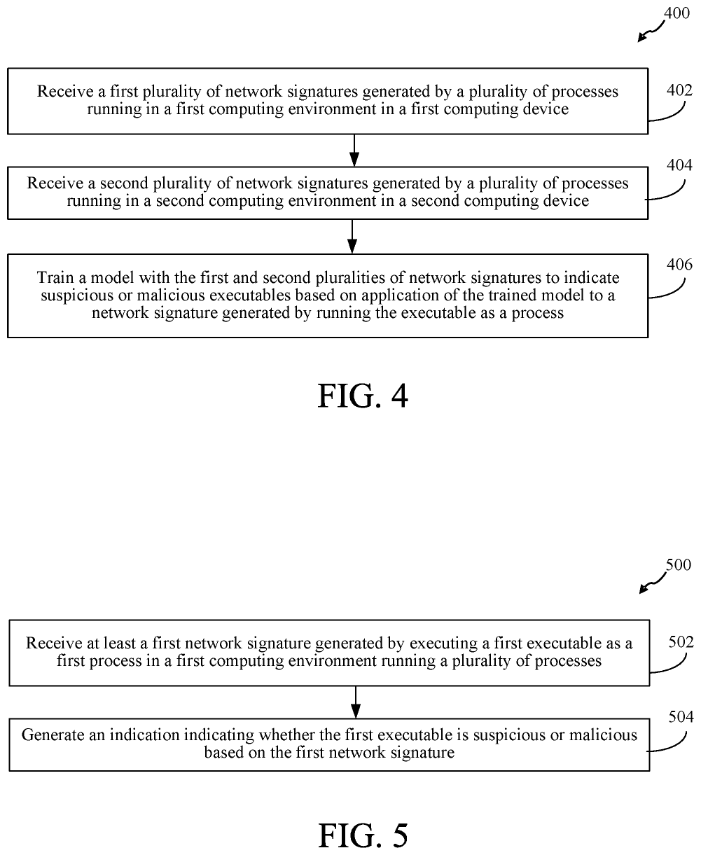

The embodiments described herein, including the systems and computing devices shown in FIGS. 1-3, may operate in various ways. For instance, FIG. 4 shows a flowchart of a method 400 for training a machine learning model to detect hacker tools based on their network activities or signatures, according to an example embodiment. Embodiments disclosed herein and other embodiments may operate in accordance with example method 400, including security service 142 (including model trainer 144). Method 400 comprises steps 402, 404, and 406. However, other embodiments may operate according to other methods. Other structural and operational embodiments will be apparent to persons skilled in the relevant art(s) based on the foregoing discussion of embodiments. No order of steps is required unless expressly indicated or inherently required. There is no requirement that a method embodiment implement all of the steps illustrated in FIG. 4. Method 400 of FIG. 4 is simply one of many possible embodiments. Embodiments may implement fewer, more or different steps.

As shown in FIG. 4, example method 400 begins with step 402 (although method 400 may alternatively start with step 404). In step 402, a first plurality of network signatures is received. A computing device or a component therein (e.g., a network interface or a suspicious process detector) may receive a first plurality of network signatures generated by a plurality of processes running in a first computing environment in a first computing device. For example, as shown in FIGS. 1-3, security server(s) 140 or security service 142 may receive a plurality of network signatures. For example, process monitors 112a-112n (e.g., network monitor 252) in any of computing devices 104a-104n may record/store in network activity log 254 (e.g., in memory or storage) network activity (e.g., events, such as network packets) for k processes running in any respective computing environments 106a-106n.

In step 404, a second plurality of network signatures is received. A computing device or a component therein (e.g., a network interface or a suspicious process detector) may receive a second plurality of network signatures generated by a plurality of processes running in a second computing environment in a second computing device. For example, as shown in FIGS. 1-3, security server(s) 140 or security service 142 may receive a plurality of network signatures. For example, process monitors 112a-112n (e.g., network monitor 252) in any of computing devices 104a-104n may record/store in network activity log 254 (e.g., in memory or storage) network activity (e.g., events, such as network packets) for k processes running in any respective computing environments 106a-106n.

In step 406, a model may be trained with the first and second pluralities of network signatures to indicate suspicious or malicious executables based on application of the trained model to a network signature generated by running the executable as a process. For example, as shown in FIGS. 1-3, model trainer 144 may train a model (e.g., trained model 148) based on the plurality of network signatures received (e.g., in the form of network activity logs 254) from multiple computing devices 104a-104n. At least one of the first and second network signatures may be labeled (e.g., pre-classified), for example, as suspicious or malicious and at least one of the first and second network signatures may be labeled, for example, as not suspicious or not malicious. Model trainer 144 may train trained model 148 to indicate suspicious or malicious executables by application of trained model 148 to a network signature (e.g., generated by running the executable as a process in a computing environment on computing device 104a-104n).

FIG. 5 shows a flowchart of a method 500 for using a trained machine learning model to detect hacker tools based on their network activities or signatures, according to an example embodiment. Embodiments disclosed herein and other embodiments may operate in accordance with example method 500, including local SPDs 116a-116n and server-based SPD 146. Method 500 comprises steps 502-504. However, other embodiments may operate according to other methods. Other structural and operational embodiments will be apparent to persons skilled in the relevant art(s) based on the foregoing discussion of embodiments. No order of steps is required unless expressly indicated or inherently required. There is no requirement that a method embodiment implement all of the steps illustrated in FIG. 5. Method 500 of FIG. 5 is simply one of many possible embodiments. Embodiments may implement fewer, more or different steps.

Example method 500 comprises steps 502 and 504. In step 502, a computer, a program or a component therein (e.g., an SPD) may receive at least a first network signature generated by executing a first executable as a first process in a first computing environment running a plurality of processes. For example, as shown in FIGS. 1-3, local SPDs 116a-116n or server-based SPD 146 may receive one or more network signatures from computing device 104a-104n (e.g., in the form of network activity log 254). For example, process monitors 112a-112n (e.g., network monitor 252) in any of computing devices 104a-104n may record/store in network activity log 254 (e.g., in memory or storage) network activity (e.g., events, such as network packets) for k processes running in any respective computing environments 106a-106n. A network activity log may indicate network events (e.g., a network signature) for one or more processes.

In step 504, an indication may be generated to indicate whether the first executable is suspicious or malicious based on the first network signature. For example, as shown in FIGS. 1-3, local SPDs 116a-116n or server-based SPD 146 may apply trained models 118a-118n or trained model 148, respectively, to received network activity log 254, which generates an indication (e.g., a classification), such as SPD result 324 of FIG. 3, indicating whether the one or more network signatures provided in network activity log 254 indicate that one or more executables on the computing device that generated/provided network activity log 254 are suspicious or malicious.

### III. Example Computing Device Embodiments

As noted herein, the embodiments described, along with any modules, components and/or subcomponents thereof, as well as the flowcharts/flow diagrams described herein, including portions thereof, and/or other embodiments, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), and/or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

FIG. 6 shows an exemplary implementation of a computing device 600 in which example embodiments may be implemented. Consistent with all other descriptions provided herein, the description of computing device 600 is a non-limiting example for purposes of illustration. Example embodiments may be implemented in other types of computer systems, as would be known to persons skilled in the relevant art(s).

As shown in FIG. 6, computing device 600 includes one or more processors, referred to as processor circuit 602, a system memory 604, and a bus 606 that couples various system components including system memory 604 to processor circuit 602. Processor circuit 602 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 602 may execute program code stored in a computer readable medium, such as program code of operating system 630, application programs 632, other programs 634, etc. Bus 606 represents one or more of any of several types of bus structures, including a memory bus or memory controller, a peripheral bus, an accelerated graphics port, and a processor or local bus using any of a variety of bus architectures. System memory 604 includes read only memory (ROM) 608 and random-access memory (RAM) 610. A basic input/output system 612 (BIOS) is stored in ROM 608.

Computing device 600 also has one or more of the following drives: a hard disk drive 614 for reading from and writing to a hard disk, a magnetic disk drive 616 for reading from or writing to a removable magnetic disk 618, and an optical disk drive 620 for reading from or writing to a removable optical disk 622 such as a CD ROM, DVD ROM, or other optical media. Hard disk drive 614, magnetic disk drive 616, and optical disk drive 620 are connected to bus 606 by a hard disk drive interface 624, a magnetic disk drive interface 626, and an optical drive interface 628, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 630, one or more application programs 632, other programs 634, and program data 636. Application programs 632 or other programs 634 may include, for example, computer program logic (e.g., computer program code or instructions) for implementing example embodiments described herein.

A user may enter commands and information into the computing device 600 through input devices such as keyboard 638 and pointing device 640. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 602 through a serial port interface 642 that is coupled to bus 606, but may be connected by other interfaces, such as a parallel port, game port, or a universal serial bus (USB).

A display screen 644 is also connected to bus 606 via an interface, such as a video adapter 646. Display screen 644 may be external to, or incorporated in computing device 600. Display screen 644 may display information, as well as being a user interface for receiving user commands and/or other information (e.g., by touch, finger gestures, virtual keyboard, etc.). In addition to display screen 644, computing device 600 may include other peripheral output devices (not shown) such as speakers and printers.

Computing device 600 is connected to a network 648 (e.g., the Internet) through an adaptor or network interface 650, a modem 652, or other means for establishing communications over the network. Modem 652, which may be internal or external, may be connected to bus 606 via serial port interface 642, as shown in FIG. 6, or may be connected to bus 606 using another interface type, including a parallel interface.

As used herein, the terms “computer program medium,” “computer-readable medium,” and “computer-readable storage medium” are used to refer to physical hardware media such as the hard disk associated with hard disk drive 614, removable magnetic disk 618, removable optical disk 622, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media that are separate and non-overlapping with embodiments directed to computer-readable storage media.

As noted above, computer programs and modules (including application programs 632 and other programs 634) may be stored on the hard disk, magnetic disk, optical disk, ROM, RAM, or other hardware storage medium. Such computer programs may also be received via network interface 650, serial port interface 642, or any other interface type. Such computer programs, when executed or loaded by an application, enable computing device 600 to implement features of example embodiments described herein. Accordingly, such computer programs represent controllers of the computing device 600.

Example embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Example Embodiments

Methods, systems and computer program products are provided for detection of hacker tools based on their network signatures. In examples, a method may determine whether one or more executables are suspicious or malicious based on the network signatures generated by the one or more executables when executed as processes. A method may comprise, for example, receiving at least a first network signature generated by executing a first executable as a first process in a first computing environment running a plurality of processes; and generating an indication indicating whether the first executable is suspicious or malicious based on the first network signature. A suspicious executable may be potentially malicious. A network signature may be a plurality of network events generated by a process.

The method may further comprise, for example, receiving at least a second network signature generated by executing a second executable as a process in a second computing environment running a plurality of processes; and generating an indication indicating whether the second executable is suspicious or malicious based on the second network signature.

In examples, receiving at least a first network signature may comprise, for example, receiving from a first computing device a first network traffic log comprising the first network signature.

In examples, the first network traffic log may comprise, for example, a plurality of network events generated by a plurality of executables executing as the plurality of processes in the first computing environment on the first computing device. A (e.g., each) network event may be associated with a process in the plurality of processes.

In examples, receiving at least a first network signature may comprise, for example, receiving from a second computing device a second network traffic log comprising a second plurality of network events generated by a plurality of executables executing as a second plurality of processes in a second computing environment on the second computing device. A (e.g., each) network event may be associated with a process in the second plurality of processes.

In examples, generating an indication indicating whether the first executable is suspicious or malicious based on the first network signature may comprise, for example, applying the first network traffic log as input to a model trained on network signatures generated by a plurality of executables executing as processes on a plurality of computing devices; and generating, by the model, the indication indicating whether the plurality of network events in the network traffic log indicate the first executable is suspicious or malicious.

In examples, the model may be trained to detect suspicious or malicious executables based on a plurality of ordered and unordered network events.

In examples, the method may further comprise, for example, running the first executable alone in an isolated environment for additional analysis based on a determination that the first executable is suspicious or malicious.

In an example, the method may further comprise, for example, determining a context of execution of the first executable based on a determination that the first executable is suspicious or malicious; and determining whether to terminate execution of the first executable based on the context of execution of the first executable.

In another example, a system comprises: at least one processor; and at least one computer readable storage medium that stores program code that includes: a suspicious process detector (SPD) configured to: receive at least a first network signature generated by executing a first executable as a first process in a first computing environment running a plurality of processes; and generate an indication of whether the first executable is suspicious or malicious based on the first network signature; wherein a suspicious executable is potentially malicious; and wherein a network signature is a plurality of network events generated by a process.

In an example, the SPD is configured to operate on a computing device to detect suspicious or malicious executables on the local computing device.

In an example, the SPD is configured to operate on a server, as a service to a plurality of computing devices, to detect suspicious or malicious executables on the plurality of computing devices.

In an example, the SPD is configured to receive a first network traffic log comprising a plurality of network events generated by a plurality of executables executing as the plurality of processes in the first computing environment on a first computing device, wherein each network event is associated with a process in the plurality of processes.

In an example, to generate the indication of whether the first executable is suspicious or malicious, the SPD is configured to: apply the first network traffic log as input to a model trained on network signatures generated by a plurality of executables executing as processes in a plurality of computing environments on a plurality of computing devices; and generate, by the model, the indication of whether the plurality of network events in the network traffic log indicate the first executable is suspicious or malicious.

In an example, the model is trained to detect suspicious or malicious executables based on a plurality of ordered and unordered network events.

A method may comprise, for example, receiving a first plurality of network signatures generated by a plurality of processes running in a first computing environment in a first computing device; receiving a second plurality of network signatures generated by a plurality of processes running in a second computing environment in a second computing device; and training the model with the first and second pluralities of network signatures to indicate suspicious or malicious executables based on application of the trained model to a network signature generated by running the executable as a process. At least one of the first and second network signatures is labeled as suspicious or malicious and at least one of the first and second network signatures may be labeled as not suspicious or not malicious. A suspicious executable may be potentially malicious. A network signature may be a plurality of network events generated by a process.

In examples, the method may further comprise, for example, receiving a plurality of network signatures from a plurality of computing devices; applying the trained model to each of the plurality of network signatures; and providing an indication, to a computing device among the plurality of computing devices, indicating whether a network signature provided by the computing device indicates an executable on the computing device is suspicious or malicious.

In examples, the method may further comprise, for example, providing the trained model to a plurality of computing devices to run locally to detect suspicious or malicious processes.

In examples, the method may further comprise, for example, providing an agent to each of a plurality of computing devices to provide a plurality of network signatures for at least one of training the model and using the trained model to detect suspicious or malicious executables.

In examples, the model may be a machine learning model.

### V. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A system, comprising:
at least one processor; and
at least one computer readable storage medium that stores program code that includes:
a suspicious process detector (SPD) configured to:
receive at least a first network signature generated by executing a first executable as a first process in a first computing environment running a plurality of processes; and
generate an indication of whether the first executable is suspicious or malicious based on the first network signature;
wherein a suspicious executable is potentially malicious; and
wherein a network signature is a plurality of network events generated by a process.

2. The system of claim 1, wherein the SPD is configured to operate on a computing device to detect suspicious or malicious executables on the local computing device.

3. The system of claim 1, wherein the SPD is configured to operate on a server, as a service to a plurality of computing devices, to detect suspicious or malicious executables on the plurality of computing devices.

4. The system of claim 1, wherein the SPD is configured to receive a first network traffic log comprising a plurality of network events generated by a plurality of executables executing as the plurality of processes in the first computing environment on a first computing device, wherein each network event is associated with a process in the plurality of processes.

5. The system of claim 4, wherein, to generate the indication of whether the first executable is suspicious or malicious, the SPD is configured to:
apply the first network traffic log as input to a model trained on network signatures generated by a plurality of executables executing as processes in a plurality of computing environments on a plurality of computing devices; and
generate, by the model, the indication of whether the plurality of network events in the network traffic log indicate the first executable is suspicious or malicious.

6. The system of claim 1, wherein the model is trained to detect suspicious or malicious executables based on a plurality of ordered and unordered network events.

7. A method of detecting a suspicious or malicious executable based on a network signature generated by the executable during processing, the method comprising:
receiving at least a first network signature generated by executing a first executable as a first process in a first computing environment running a plurality of processes; and
generating an indication indicating whether the first executable is suspicious or malicious based on the first network signature;
wherein a suspicious executable is potentially malicious; and
wherein a network signature is a plurality of network events generated by a process.

8. The method of claim 7, further comprising:
receiving at least a second network signature generated by executing a second executable as a process in a second computing environment running a plurality of processes; and
generating an indication indicating whether the second executable is suspicious or malicious based on the second network signature.

9. The method of claim 7, wherein receiving at least a first network signature comprises:
receiving from a first computing device a first network traffic log comprising the first network signature.

10. The method of claim 9, wherein the first network traffic log comprises a plurality of network events generated by a plurality of executables executing as the plurality of processes in the first computing environment on the first computing device, wherein each network event is associated with a process in the plurality of processes.

11. The method of claim 10, wherein receiving at least a first network signature comprises:
receiving from a second computing device a second network traffic log comprising a second plurality of network events generated by a plurality of executables executing as a second plurality of processes in a second computing environment on the second computing device, wherein each network event is associated with a process in the second plurality of processes.

12. The method of claim 9, wherein generating an indication indicating whether the first executable is suspicious or malicious based on the first network signature comprises:
applying the first network traffic log as input to a model trained on network signatures generated by a plurality of executables executing as processes on a plurality of computing devices; and
generating, by the model, the indication indicating whether the plurality of network events in the network traffic log indicate the first executable is suspicious or malicious.

13. The method of claim 12, wherein the model is trained to detect suspicious or malicious executables based on a plurality of ordered and unordered network events.

14. The method of claim 7, further comprising:
based on a determination that the first executable is suspicious or malicious, running the first executable alone in an isolated environment for additional analysis.

15. The method of claim 7, further comprising:
based on a determination that the first executable is suspicious or malicious, determining a context of execution of the first executable; and
determining whether to terminate execution of the first executable based on the context of execution of the first executable.

16. A method comprising:
receiving a first plurality of network signatures generated by a plurality of processes running in a first computing environment in a first computing device;
receiving a second plurality of network signatures generated by a plurality of processes running in a second computing environment in a second computing device; and
training the model with the first and second pluralities of network signatures to indicate suspicious or malicious executables based on application of the trained model to a network signature generated by running the executable as a process;
wherein at least one of the first and second network signatures is labeled as suspicious or malicious and at least one of the first and second network signatures is labeled as not suspicious or not malicious;
wherein a suspicious executable is potentially malicious; and
wherein a network signature is a plurality of network events generated by a process.

17. The method of claim 16, further comprising:
receiving a plurality of network signatures from a plurality of computing devices;
applying the trained model to each of the plurality of network signatures; and
providing an indication, to a computing device among the plurality of computing devices, indicating whether a network signature provided by the computing device indicates an executable on the computing device is suspicious or malicious.

18. The method of claim 16, further comprising:
providing the trained model to a plurality of computing devices to run locally to detect suspicious or malicious processes.

19. The method of claim 16, further comprising:
providing an agent to each of a plurality of computing devices to provide a plurality of network signatures for at least one of training the model and using the trained model to detect suspicious or malicious executables.

20. The method of claim 16, wherein the model is a machine learning model.
